(19) United States
(12) Patent Application Publication
(10) Pub. No.: US 2021/0064130 A1
(43) Pub. Date: Mar. 4, 2021

(54) MOBILE TERMINAL, CONTROL METHOD FOR MOBILE TERMINAL, AND STORAGE MEDIUM STORING PROGRAM FOR MOBILE TERMINAL

(71) Applicant: NEC Platforms, Ltd., Kawasaki-shi, Kanagawa (JP)

(72) Inventor: Hideki NOMOTO, Kanagawa (JP)

(73) Assignee: NEC Platforms, Ltd., Kawasaki-shi, Kanagawa (JP)

(21) Appl. No.: 16/964,865

(22) PCT Filed: Feb. 5, 2019
(86) PCT No.: PCT/JP2019/004040

§ 371 Date: Jul. 24, 2020

(30) Foreign Application Priority Data
Feb. 8, 2018 (JP) 2018-020711

(51) Int. Cl. G06F 3/01; G06F 3/0346; G06K 9/00

(52) U.S. Cl. CPC G06F 3/013; G06K 9/00281; G06K 9/00604; G06F 3/0346

(57) ABSTRACT

In order to implement a mobile terminal that is able to determine with high accuracy whether a user is operating the mobile terminal, the mobile terminal according to the present invention, which is equipped with a display unit, comprises an imaging unit that is immobile relative to the display unit, and captures an image of the surface of an eyeball of the user of the mobile terminal, and a control unit that determines that the user is operating the mobile terminal when, within a first prescribed amount of time, the amount of time that the image of the surface of the eyeball is aligned with an image displayed on the display unit is equal to or greater than a second prescribed amount of time shorter than the first prescribed amount of time.

### TECHNICAL FIELD

The present invention relates to a mobile terminal, a control method for a mobile terminal, and a program for a mobile terminal.

### BACKGROUND ART

When a user of a mobile terminal such as a mobile phone and a smart phone looks at or operates a display screen while walking, an accident often occurs such as colliding with another person or a vehicle, or falling off from a platform at a station, and this has become a social problem.

In view of this, PTL 1 proposes a technique of limiting a function of a mobile terminal when the mobile terminal detects a motion of a visual line of an eye of a user while moving and determines that the user moves while looking at a display unit.

### CITATION LIST

### Patent Literature

[PTL 1] Japanese Unexamined Patent Application Publication No. 2015-099493

### SUMMARY OF INVENTION

### Technical Problem

In the technique according to PTL 1, whether a user is in the middle of operating a mobile terminal is determined based on a motion of a visual line of the user of the mobile terminal.

However, in a case of a mobile terminal including a large screen, such as a tablet terminal, a motion of a visual line also becomes large when a display range on the screen is being viewed. Further, when a distance between a display screen of a mobile terminal and an eye of a user is short, a motion of a visual line is larger than a case where the distance is long.

Thus, when determination on whether a user of a mobile terminal is in the middle of operating the mobile terminal is performed through use of a motion of a visual line of the user as proposed in PTL 1, there arises a problem that determination accuracy is low.

In view of the problem described above, an object of the present invention is to provide a mobile terminal, a control method for a mobile terminal, and a program for a mobile terminal that perform highly accurate determination on whether a user of the mobile terminal is in the middle of operating the mobile terminal.

### Solution to Problem

In order to achieve the above-mentioned object, a mobile terminal according to the present invention is a mobile terminal including a display unit, and includes an imaging unit that captures an image of a surface of an eyeball of a user of the mobile terminal, the imaging unit being fixed relatively to the display unit, and a control unit that determines that the user is in the middle of operating the mobile terminal when, within a first predetermined time period, a time period during which the image of the surface of the eyeball matches with an image displayed on the display unit is equal to or longer than a second predetermined time period that is shorter than the first predetermined time period.

In order to achieve the above-mentioned object, a control method for a mobile terminal according to the present invention includes determining that a user of a mobile terminal is in the middle of operating the mobile terminal when, within a first predetermined time period, a time period during which an image of a surface of an eyeball of the user matches with an image displayed on a display unit of the mobile terminal is equal to or longer than a second predetermined time period that is shorter than the first predetermined time period.

In order to achieve the above-mentioned object, a program for a mobile terminal according to the present invention causes a computer to determine that a user of a mobile terminal is in the middle of operating the mobile terminal when, within a first predetermined time period, a time period during which an image of a surface of an eyeball of the user matches with an image displayed on a display unit of the mobile terminal is equal to or longer than a second predetermined time period that is shorter than the first predetermined time period.

### Advantageous Effects of Invention

According to the present invention, the mobile terminal, the control method for a mobile terminal, and the program for a mobile terminal enable highly accurate determination on whether a user of a mobile terminal is in the middle of operating the mobile terminal.

### BRIEF DESCRIPTION OF DRAWINGS

FIG. 1 is a diagram illustrating a configuration example according to first and second example embodiments.

FIG. 2 is a diagram describing an operation according to the second example embodiment.

FIG. 3 is a diagram describing an operation according to a third example embodiment.

FIG. 4 is a diagram illustrating a configuration example according to fourth and fifth example embodiments.

FIG. 5 is a diagram describing an operation according to the fourth example embodiment.

FIG. 6 is a diagram describing an operation according to the fifth example embodiment.

FIG. 7 is a diagram illustrating a configuration example according to sixth and seventh example embodiments.

FIG. 8 is a diagram describing an operation according to the sixth example embodiment.

FIG. 9 is a diagram describing an operation according to the seventh example embodiment.

### EXAMPLE EMBODIMENT

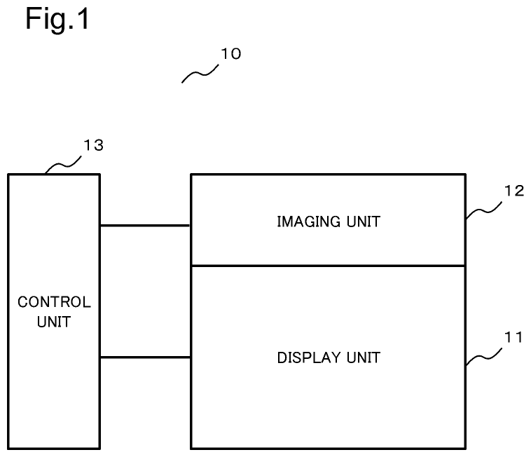

Next, an example embodiment of the present invention is described in detail with reference to FIG. 1.

FIG. 1 illustrates a configuration of a first example embodiment.

A mobile terminal 10 according to the present example embodiment is a mobile terminal including a display unit 11, and includes an imaging unit 12 that is fixed relatively to the display unit 11 and captures an image of a surface of an eyeball of a user of the mobile terminal, and a control unit 13. The control unit 13 determines that the user is in the middle of operating the mobile terminal 10 when, within a first predetermined time period, a time period during which the image of the surface of the eyeball matches with an image displayed on the display unit 11 is equal to or longer than a second predetermined time period that is shorter than the first predetermined time period.

In this manner, determination on whether a user of a mobile terminal is in the middle of operating the mobile terminal can be performed at higher accuracy as compared to a case where determination is performed only based on a motion of a visual line.

### Second Example Embodiment

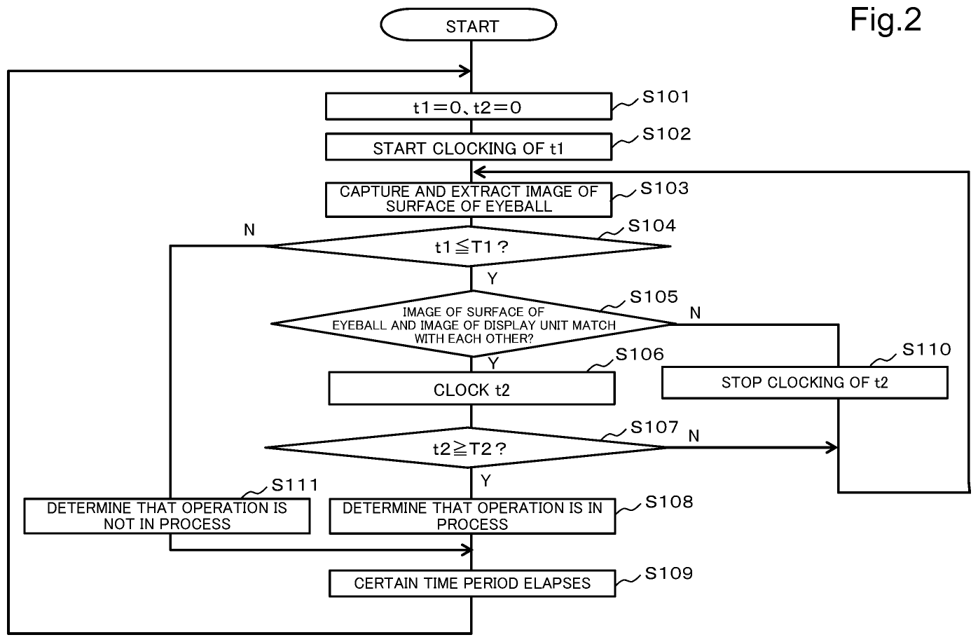

Next, a second example embodiment is described with reference to FIGS. 1 and 2.

### Description of Configuration

FIG. 1 illustrates a configuration of the second example embodiment.

The configuration of the present example embodiment is similar to the configuration of the first example embodiment.

A mobile terminal 10 includes a display unit 11, an imaging unit 12, and a control unit 13.

The mobile terminal 10 according to the present example embodiment is assumed to be a smart phone being a wireless mobile terminal. However, the mobile terminal 10 does not necessarily have to be a wireless mobile terminal, and may be a mobile video reproduction device or the like without a wireless function.

The display unit 11 is assumed to be a touch panel of a smart phone, and functions as both a display means and an input means touched by a fingertip. However, the input means is not necessarily included, and the gist of the invention described in the present example embodiment is not impaired.

The imaging unit 12 is a camera, and is a so-called inner camera that is fixed to the same surface as the display unit and is capable of capturing an image of a face of a user. Note that, in a general smart phone, the inner camera is attached to the same surface as the touch panel in many cases. However, the imaging unit 12 may be a camera that is capable of capturing an image of a face of a user of the mobile terminal 10 and is installed at a position fixed relatively to the display unit.

The control unit 13 includes a central processing unit (CPU), controls hardware of the mobile terminal 10, and executes software processing.

### Description of Operation

The mobile terminal 10 according to the present example embodiment determines that a user of the mobile terminal 10 is in the middle of operating the mobile terminal 10 when, within a previously determined time period T1 (first predetermined time period), the user stares at the display unit 11 for a time period T2 (second predetermined time period) or longer.

Further, the mobile terminal 10 determines that a user of the mobile terminal 10 is not in the middle of operating the mobile terminal 10 when, within the time period T1, the user looks at the display unit 11 only for a time period shorter than the time period T2.

An operation of the mobile terminal 10 that achieves such a mobile terminal 10 is described with reference to FIG. 2.

When the mobile terminal 10 starts an operation, the control unit 13 sets a time period t1 to zero, and sets a time period t2 to zero (S101).

Herein, it is assumed that a clocking function included in the control unit 13 is used for clocking of a time period, but the mobile terminal 10 may include a clocking function separately from the control unit 13.

The control unit 13 starts clocking of the time period t1 (S102).

The control unit 13 operates the imaging unit 12, and causes the imaging unit 12 to capture an image of a surface of an eyeball of a user of the mobile terminal 10. Subsequently, the control unit 13 extracts an image reflected on the surface of the eyeball (S103).

Extraction of an image on a surface of an eyeball is a technique that has been widely achieved nowadays, and hence description therefor is omitted.

In Step S104, the control unit 13 determines whether t1 is within the time period T1 (S104).

Herein, the time period T1 is a previously determined time period.

When it is determined that t1 is within the time period T1 in Step S104 (Y in S104), the procedure proceeds to Step S105.

When it is determined that t1 is not within the time period T1 in Step S104 (N in S104), the procedure proceeds to Step S111.

In Step S105, the control unit 13 determines whether the image of the surface of the eyeball matches with an image of the display unit 11 (S105).

When the user of the mobile terminal 10 stares at the display unit 11, the image of the surface of the eyeball and the image of the display unit 11 match with each other. Determination in Step S105 is made on whether the user of the mobile terminal 10 stares at the display unit 11.

When it is determined that the image of the surface of the eyeball and the image of the display unit 11 match with each other in Step S105 (Y in S105), the procedure proceeds to Step S106.

When it is determined that the image of the surface of the eyeball and the image of the display unit 11 do not match with each other in Step S105 (N in S105), the procedure proceeds to Step S110.

In Step S106, the control unit 13 performs clocking of t2 (S106).

Herein, clocking of t2 is started from zero when clocking of t2 is stopped directly before Step S106, and clocking of t2 is continued when clocking of t2 is in process.

In Step S107, the control unit 13 determines whether t2 is equal to or longer than the time period T2 (S107).

Herein, the time period T2 is a previously determined time period, and is set to be shorter than the time period T1.

When it is determined that t2 is equal to or longer than the time period T2 in Step S107 (Y in S107), the procedure proceeds to Step S108.

When it is determined that t2 is not equal to or longer than the time period T2 in Step S107 (N in S107), the procedure returns to Step S103.

In Step S108, the control unit 13 determines that the mobile terminal 10 is being operated by the user (S108).

Step S108 indicates a situation in which the user of the mobile terminal 10 stares at the display unit 11 for the time period T2 or longer within the time period T1. This situation is determined as that the mobile terminal 10 is being operated by the user.

In Step S109, the control unit 13 stands by until a certain time period elapses (S109).

The certain time period in Step S109 is determined in accordance with a time interval at which determination on whether an operation is in process is performed.

After Step S109, the procedure returns to Step S101.

In Step S110, the control unit 13 stops clocking of t2 (S110).

After Step S110, the procedure returns to Step S103.

In Step S111, the control unit 13 determines that the mobile terminal 10 is being operated by the user (S111).

Step S111 indicates a situation in which the user of the mobile terminal 10 does not stare at the display unit 11 for the time period T2 or longer within the time period T1. Specifically, the display unit 11 is stared at only for a time period shorter than T2 within the time period T1. In such a situation, it is determined that the mobile terminal 10 is being operated by the user.

After Step S111, the procedure proceeds to Step S109.

The control unit 13 determines in Step S108 and Step S111 whether the mobile terminal 10 is being operated by the user, which can be used as information for the operation of application software of the mobile terminal 10 or the like.

In this manner, with the mobile terminal 10 according to the present example embodiment, determination on whether a user of the mobile terminal 10 is in the middle of operating the mobile terminal 10 can be performed at higher accuracy as compared to a case where determination is performed only based on a motion of a visual line.

### Third Example Embodiment

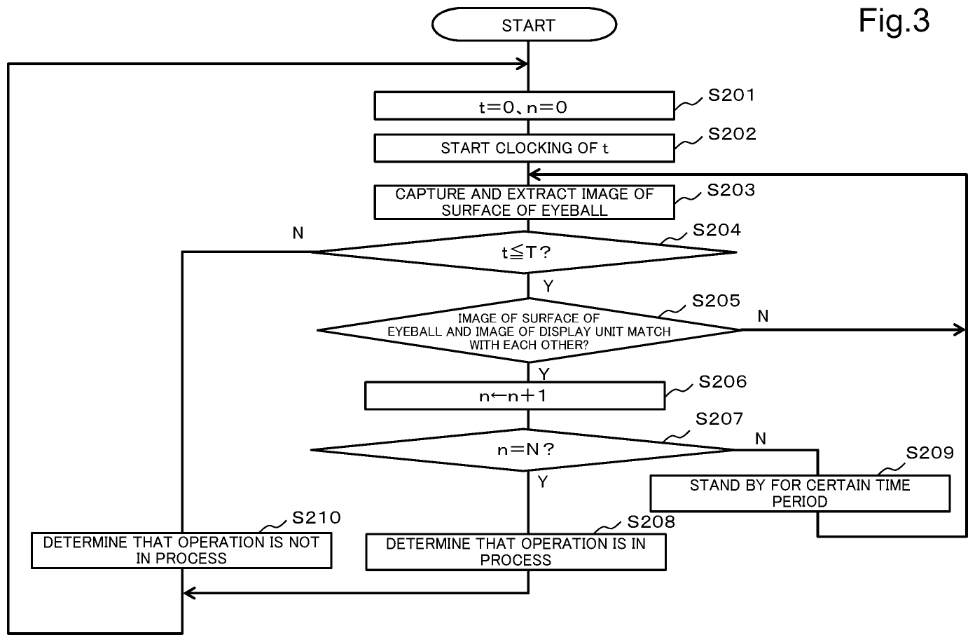

Next, a third example embodiment is described with reference to FIGS. 1 and 3.

### Description of Configuration

A configuration of the present example embodiment is similar to the configuration of the first and second example embodiments illustrated in FIG. 1, and an operation of the control unit 13 is different from that of the first and second example embodiments.

### Description of Operation

The mobile terminal 10 according to the present example embodiment determines that a user of the mobile terminal 10 is in the middle of operating the mobile terminal 10 when, within a previously determined time period T, the user stares at the display unit 11 N times.

Further, the mobile terminal 10 determines that a user of the mobile terminal 10 is not in the middle of operating the mobile terminal 10 when, within the time period T, the user looks at the display unit 11 only the number of times that is less than N times.

The operation of the mobile terminal 10 that achieves such a mobile terminal 10 is described with reference to FIG. 3.

When the mobile terminal 10 starts an operation, the control unit 13 sets a time period t to zero, and sets a counter n to zero (S201).

Herein, it is assumed that a clocking function included in the control unit 13 is used for clocking of a time period, but the mobile terminal 10 may include a clocking function separately from the control unit 13.

Further, it is assumed that a counting function included in the control unit 13 is used as a counter for counting the number of times, but the mobile terminal 10 may include a counter separately from the control unit 13.

The control unit 13 starts clocking of the time period t (S202).

Step S203 is similar to Step S103 in FIG. 2 described in the second example embodiment (S203).

In Step S204, the control unit 13 determines whether t is within the time period T (S204).

Herein, the time period T is the previously determined time described above.

When it is determined that t is within the time period T in Step S204 (Y in S204), the procedure proceeds to Step S205.

When it is determined that t is not within the time period T in Step S204 (N in S204), the procedure proceeds to Step S210.

In Step S205, the control unit 13 determines whether the image of the surface of the eyeball and an image of the display unit 11 match with each other (S205).

When the user of the mobile terminal 10 stares at the display unit 11, the image of the surface of the eyeball and the image of the display unit 11 match with each other. Determination in Step S205 is made on whether the user of the mobile terminal 10 stares at the display unit 11.

When it is determined that the image of the surface of the eyeball and the image of the display unit 11 match with each other in Step S205 (Y in S205), the procedure proceeds to Step S206.

When it is determined that the image of the surface of the eyeball and the image of the display unit 11 do not match with each other in Step S205 (N in S205), the procedure returns to Step S203.

In Step S206, the control unit 13 adds one to the counter n (S206).

In Step S207, the control unit 13 determines whether the counter n is equal to a number of times N (S207).

Herein, the number of times N is a previously determined number of times.

When it is determined that n is equal to the number of times N in Step S207 (Y in S207), the procedure proceeds to Step S208.

When it is determined that n is not equal to the number of times N in Step S207 (N in S207), the procedure proceeds to Step S209.

In Step S208, the control unit 13 determines that the mobile terminal 10 is being operated by the user (S208).

Step S208 indicates a situation in which the user of the mobile terminal 10 stares at the display unit 11 N times within the time period T. This situation is determined as that the mobile terminal 10 is being operated by the user.

After Step S208, the procedure returns to Step S201.

In Step S209, the control unit 13 stands by for a certain time period (S209).

The standby time is set at the time of designing the mobile terminal 10 together with setting of the time period T and the number of times N, as a reference for determining whether the user of the mobile terminal 10 is in in the middle of operating the mobile terminal 10.

After Step S209, the procedure returns to Step S203.

In Step S210, the control unit 13 determines that the mobile terminal 10 is being operated by the user (S210).

Step S210 indicates a situation in which the user of the mobile terminal 10 stares at the display unit 11 only the number of times that is less than N times within the time period T. This situation is determined as that the mobile terminal 10 is being operated by the user.

After Step S210, the procedure returns to Step S201.

The control unit 13 determines in Step S208 and Step S210 whether the mobile terminal 10 is being operated by the user, which can be used as information for the operation of application software of the mobile terminal 10 or the like.

In this manner, with the mobile terminal 10 according to the present example embodiment, determination on whether a user of the mobile terminal 10 is in the middle of operating the mobile terminal 10 can be performed at higher accuracy as compared to a case where determination is performed only based on a motion of a visual line.

### Fourth Example Embodiment

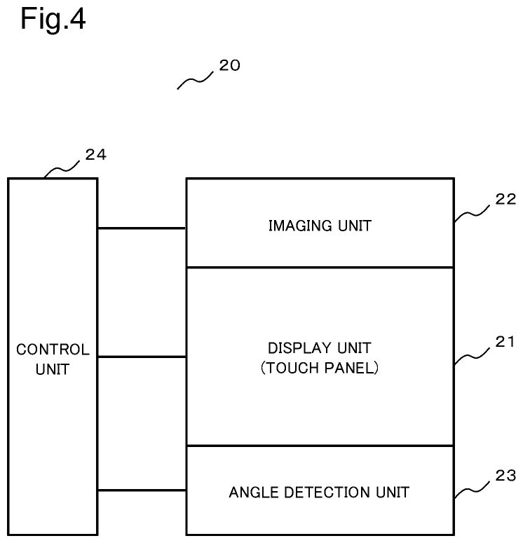

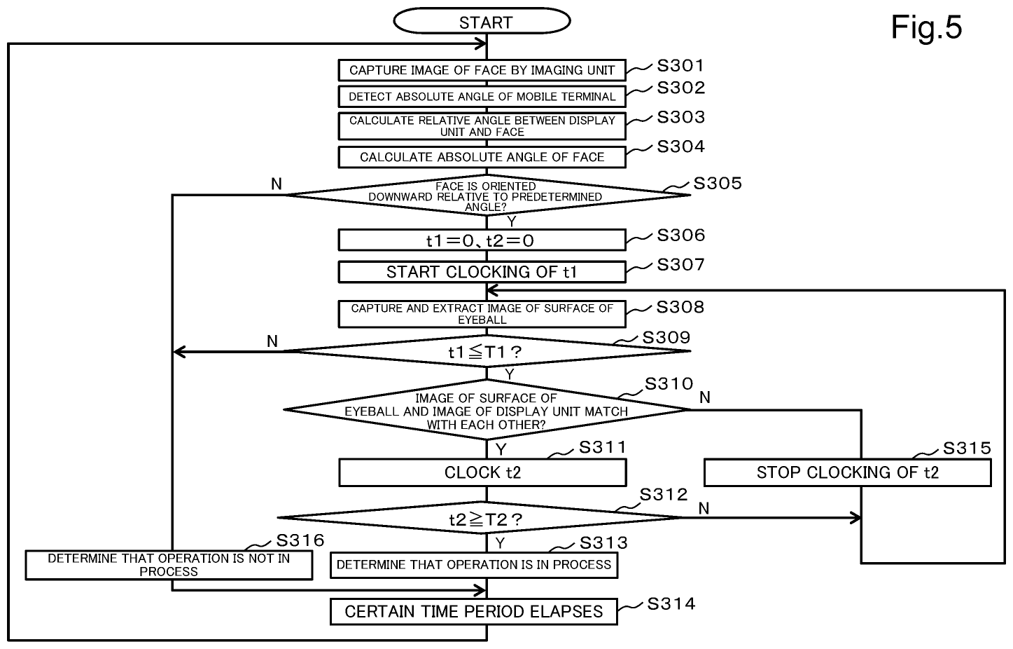

Next, a fourth example embodiment is described with reference to FIGS. 4 and 5.

### Description of Configuration

FIG. 4 illustrates a configuration of the fourth example embodiment.

A mobile terminal 20 includes a display unit 21, an imaging unit 22, an angle detection unit 23, and a control unit 24.

The mobile terminal 20 according to the present example embodiment is assumed to be a smart phone being a wireless mobile terminal. However, the mobile terminal 20 does not necessarily have to be a wireless mobile terminal, and may be a mobile video reproduction device or the like without a wireless function.

The display unit 21, the imaging unit 22, and the control unit 24 are similar to the display unit 11, the imaging unit 12, and the control unit 13 according to the second and third example embodiments.

The angle detection unit 23 may be a gyroscope. A gyroscope is a means for detecting an absolute inclination angle of the mobile terminal 20 with respect to a vertical direction. Many models of a smart phone include a gyroscope.

### Description of Operation

Next, an operation of the mobile terminal 20 according to the present example embodiment is described with reference to FIG. 5.

In FIG. 5, Step S301 to Step S305 are added to FIG. 2 describing the operation of the second example embodiment. Step S306 to Step S316 are similar to Step S101 to Step S111 in FIG. 2 describing the operation of the second example embodiment.

First, the control unit 24 operates the imaging unit 22, and causes the imaging unit 22 to capture an image of a face of a user of the mobile terminal 20 (S301).

The control unit 24 operates the angle detection unit 23, and causes the angle detection unit 23 to detect an absolute inclination angle of the mobile terminal 20 with respect to the vertical direction (S302).

Further, the control unit 24 analyzes the image of the face of the user, which is captured in Step S301, and calculates a relative angle of the face with respect to a surface of the display unit 21 (S303).

Calculation of the relative angle of the face with respect to the surface of the display unit 21 from the image of the face can be performed as detection of orientation of the face through use of a face image processing technique.

The control unit 24 calculates an absolute angle of the face from the absolute inclination angle of the mobile terminal 20, which is detected in Step S302, and the relative angle of the face with respect to the display unit 21, which is calculated in Step S303 (S304).

Subsequently, the control unit 24 determines whether the face is oriented downward relative to a predetermined angle, based on the absolute angle of the face calculated in Step S304 (S305).

Herein, the expression that the face of the user of the mobile terminal 20 is oriented downward relative to the predetermined angle indicates a state in which the user is in a facedown position and the face of the user does not gaze frontward. Further, the expression of not being downward relative to the predetermined angle, i.e., being upward indicates a state in which the user is not in a facedown position and the face of the user is oriented frontward.

When it is determined that the face is oriented downward relative to the predetermined angle in Step S305 (Y in S305), the procedure proceeds to Step S306.

When it is determined that the face is not oriented downward relative to the predetermined angle in Step S305 (N in S305), the procedure proceeds to Step S316.

Step S306 to Step S316 are similar to Step S101 to Step S111 in FIG. 2 describing the operation of the second example embodiment, and hence description therefor is omitted.

When the operation from Step S301 to Step S305 is added to the operation of the second example embodiment as described above, the following effects are exerted.

In the second example embodiment, whether the user of the mobile terminal stares at the display unit is determined only based on the image of the surface of the eyeball. However, for the image of the surface of the eyeball, only a small part of the image of the face is used, and hence image extraction processing is complicated and slow as compared to a case where a facedown state is determined by using the image of the entire face.

Meanwhile, in the present example embodiment, by omitting the processing of extracting the image of the surface of the eyeball and determining the facedown state first, a frontward gazing state of the user is determined at high speed. Then, in a facedown case, it is determined whether the user stares at the mobile terminal through use of the image of the surface of the eyeball.

Further, the mobile terminal 20 according to the present example embodiment determines that the user is in the middle of operating the mobile terminal through use of both the facedown state and the image of the surface of the eyeball, and hence determination that the operation is in process can be performed at higher accuracy as compared to the mobile terminal 10 according to the second example embodiment.

In this manner, the mobile terminal 20 according to the present example embodiment can determine whether a user of the mobile terminal is in the middle of operation at higher speed and higher accuracy as compared to the mobile terminal 10 according to the second example embodiment.

### Fifth Example Embodiment

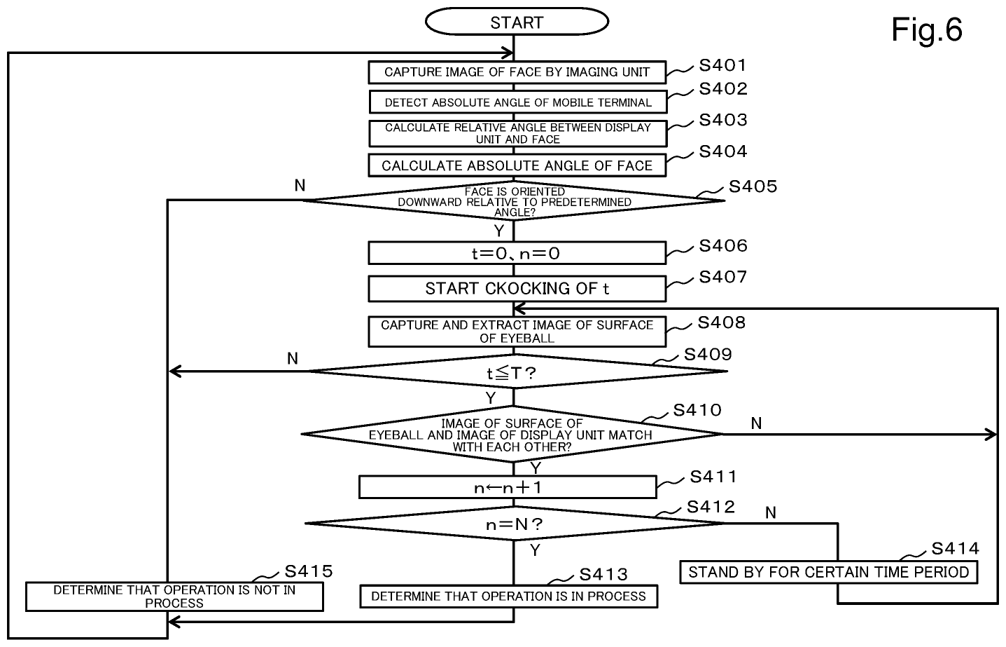

Next, a fifth example embodiment is described with reference to FIGS. 4 and 6.

### Description of Configuration

A configuration of the present example embodiment is similar to the configuration of the fourth example embodiment illustrated in FIG. 4, and an operation of the control unit 24 is different from that of the fourth example embodiment.

### Description of Operation

Next, an operation of the mobile terminal 20 according to the present example embodiment is described with reference to FIG. 6.

Step S401 to Step S405 are similar to Step S301 to Step S305 in FIG. 5 describing the operation of the fourth example embodiment.

Further, Step S406 to Step S415 are similar to Step S201 to Step S210 in FIG. 3 describing the operation of the third example embodiment.

As described above, the operation from Step S401 to Step S405 is added to the operation of the third example embodiment. Thus, similarly to the mobile terminal 20 according to the fourth example embodiment, determination on that a user is in the middle of operating the mobile terminal is performed through use of both a facedown state and an image of an surface of an eyeball.

In this manner, the mobile terminal 20 according to the present example embodiment can determine whether a user of the mobile terminal is in the middle of operation at higher speed and higher accuracy as compared to the mobile terminal 10 according to the third example embodiment.

### Sixth Example Embodiment

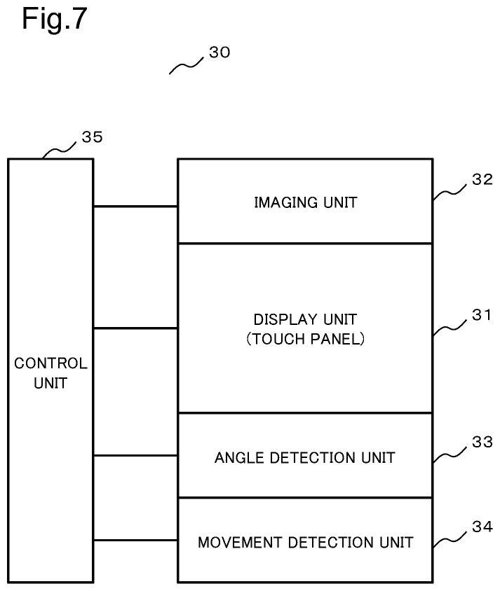

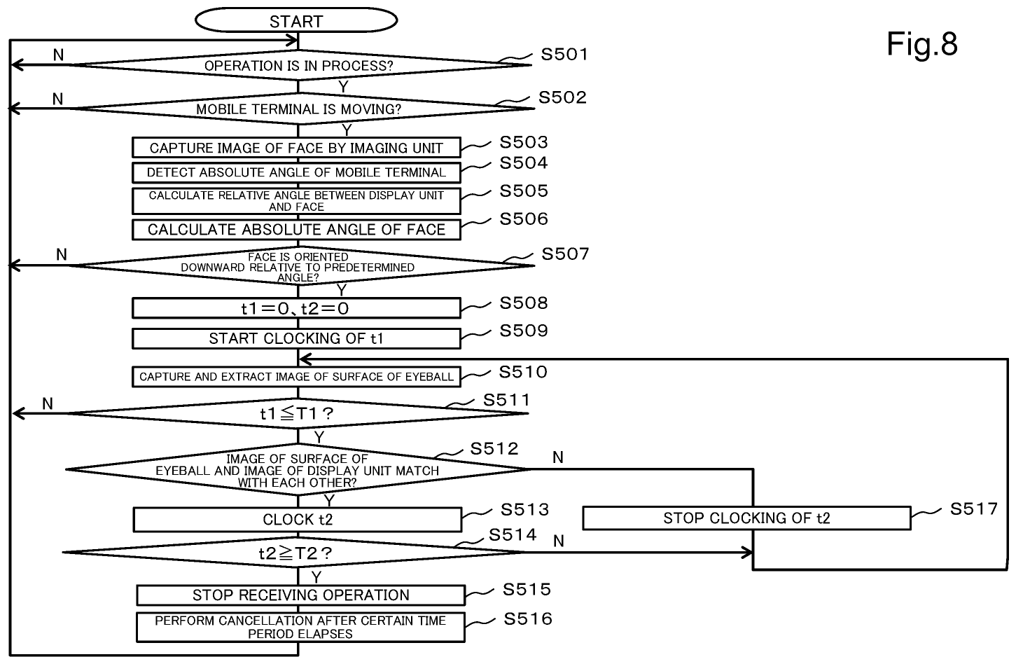

Next, a sixth example embodiment is described with reference to FIGS. 7 and 8.

### Description of Configuration

FIG. 7 illustrates a configuration of the sixth example embodiment.

A mobile terminal 30 includes a display unit 31, an imaging unit 32, an angle detection unit 33, a movement detection unit 34, and a control unit 35.

The mobile terminal 30 according to the present example embodiment is assumed to be a smart phone being a wireless mobile terminal. However, the mobile terminal 30 does not necessarily have to be a wireless mobile terminal, and may be a mobile video reproduction device or the like without a wireless function.

The display unit 31, the imaging unit 32, the angle detection unit 33, and the control unit 35 are similar to the display unit 21, the imaging unit 22, the angle detection unit 23, and the control unit 24 according to the fourth and example embodiments.

The movement detection unit 34 may use the global positioning system (GPS) and measure a current location of the mobile terminal 30, and may detect that the mobile terminal 30 is moving when the current location changes over time. Many models of a smart phone include a GPS function.

### Description of Operation

Next, an operation of the mobile terminal 30 according to the present example embodiment is described with reference to FIG. 8.

In FIG. 8, Step S501 and Step S502 are added to FIG. 5 describing the operation of the fourth example embodiment. Step S503 to Step S514 and Step S517 are similar to Step S301 to Step S312 and Step S315 in FIG. 5 describing the operation of the fourth example embodiment.

Further, Step S313 in FIG. 5 is removed and replaced with Step S515 and Step S516 in FIG. 8.

Moreover, Step S316 in FIG. 5 is removed, and the procedure returns to Step S501 in FIG. 8.

First, the control unit 35 determines whether a user of the mobile terminal 30 is in the middle of operating a touch panel being the display unit 31 (S501).

Herein, determination on whether an operation is in process may be made by detecting whether the user is in contact with the touch panel, and determining that an operation is in process when the contact is detected within a certain time period.

Note that the mobile terminal 30 may include an input means with a button provided separately from the display unit 31, and may determine whether an operation is in process by detecting an operation of the button.

When it is determined that an operation is in process in Step S501 (Y in S501), the procedure proceeds to Step S502.

When it is determined that an operation is not in process in Step S501 (N in S501), the procedure returns to Step S501.

In Step S502, the control unit 35 operates the movement detection unit 34, and determines whether the mobile terminal 30 is moving (S502).

When it is determined that the mobile terminal 30 is moving in Step S502 (Y in S502), the procedure proceeds to Step S503.

When it is determined that the mobile terminal 30 is not moving in Step S502 (N in S502), the procedure returns to Step S501.

Step S503 to Step S514 and Step S517 are similar to Step S301 to Step S312 and Step S315 in FIG. 5 describing the operation of the fourth example embodiment.

In Step S515, the control unit 35 stops receiving an input operation of the touch panel of the display unit 31 (S515).

In Step S516, after a previously determined certain time period elapses, the stop of the input operation of the touch panel of the display unit 31 is cancelled (S516).

In this manner, when it is determined that the mobile terminal 30 is moving and that the user of the mobile terminal 30 is in the middle of using the mobile terminal 30 without gazing frontward, reception of the input operation of the touch panel of the display unit 31 is stopped.

As a result, the user of the mobile terminal 30 is forced to stop the input operation of the mobile terminal 30, and moves while gazing frontward. Further, the user of the mobile terminal 30 can avoid a risk.

As described above, by determining whether a user of a mobile terminal is in the middle of operating the mobile terminal at high accuracy, the mobile terminal 30 according to the present example embodiment allows the user to avoid a risk of performing the input operation during moving such as walking.

### Seventh Example Embodiment

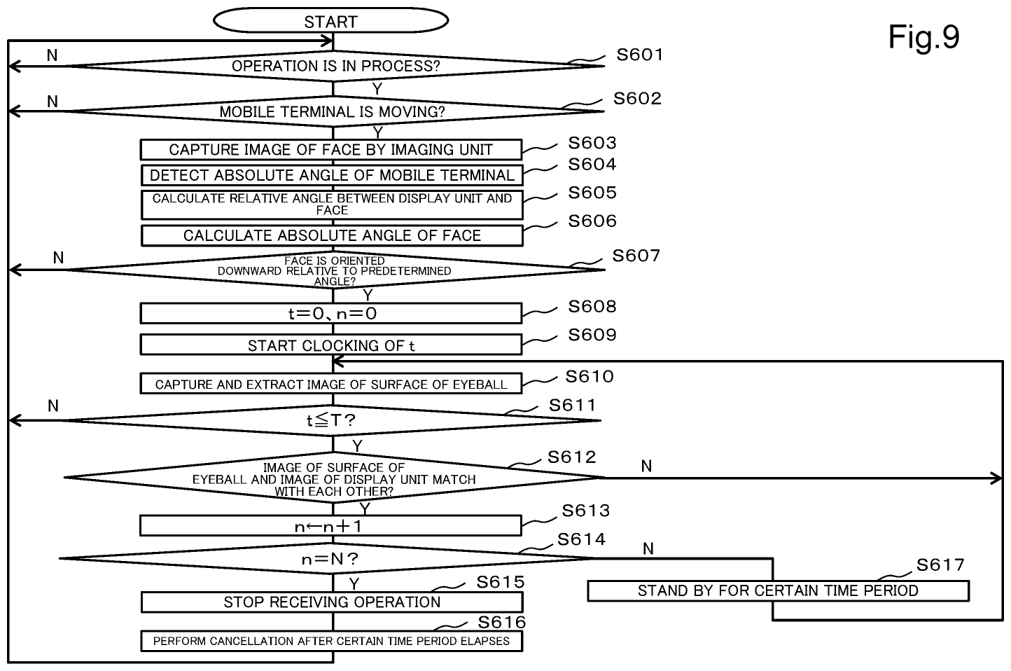

Next, a seventh example embodiment is described with reference to FIGS. 7 and 9.

### Description of Configuration

A configuration of the present example embodiment is similar to the configuration of the sixth example embodiment illustrated in FIG. 7, and an operation of the control unit 35 is different from that of the sixth example embodiment.

### Description of Operation

Next, an operation of the mobile terminal 30 according to the present example embodiment is described with reference to FIG. 9.

In FIG. 9, Step S601 and Step S602 are added to FIG. 6 describing the operation of the fifth example embodiment. Step S603 to Step S614 and Step S617 are similar to Step S401 to Step S412 and Step S414 in FIG. 5 describing the operation of the fifth example embodiment.

Further, Step S413 in FIG. 6 is removed and replaced with Step S615 and Step S616 in FIG. 9.

Moreover, Step S415 in FIG. 6 is removed, and the procedure returns to Step S601 in FIG. 9.

Step S601 and Step S602 are similar to Step S501 and Step S502 in FIG. 8 describing the operation of the sixth example embodiment.

Step S603 to Step S614 and Step S617 are similar to Step S401 to Step S412 and Step S414 in FIG. 6 describing the operation of the fifth example embodiment.

Further, Step S615 and Step S616 are similar to Step S515 and Step S516 in FIG. 8 describing the operation of the sixth example embodiment.

In this manner, similarly to the mobile terminal 30 according to the sixth example embodiment, when it is determined that the mobile terminal 30 is moving and that a user of the mobile terminal 30 is in the middle of using the mobile terminal 30 without gazing frontward, reception of an input operation of a touch panel of the display unit 31 is stopped.

As a result, the user of the mobile terminal 30 is forced to stop the input operation of the mobile terminal 30, and moves while gazing frontward. Further, the user of the mobile terminal 30 can avoid a risk.

As described above, the mobile terminal 30 according to the present example embodiment allows, by determining whether a user of the mobile terminal is in the middle of operating the mobile terminal at high accuracy, the user to avoid a risk of performing the input operation during moving such as walking.

Note that the present invention is also applicable to a case where an information processing program for achieving the functions of the example embodiments is supplied to a system or a device directly or remotely.

The whole or part of the example embodiments disclosed above can be described as, but not limited to, the following supplementary notes.

### Supplementary Note 1

A mobile terminal including a display unit, the mobile terminal including:

an imaging unit being configured to capture an image of a surface of an eyeball of a user of the mobile terminal, the imaging unit being fixed relatively to the display unit; and

a control unit being configured to determine that the user is in the middle of operating the mobile terminal when, within a first predetermined time period, a time period during which the image of the surface of the eyeball matches with an image being displayed on the display unit is equal to or longer than a second predetermined time period that is shorter than the first predetermined time period.

### Supplementary Note 2

A mobile terminal including a display unit, the mobile terminal including:

an imaging unit being configured to capture an image of a surface of an eyeball of a user of the mobile terminal, the imaging unit being fixed relatively to the display unit; and

a control unit being configured to determine that the user is in the middle of operating the mobile terminal when, within a predetermined time period, the number of times that the image of the surface of the eyeball matches with an image being displayed on the display unit reaches a predetermined number of times.

### Supplementary Note 3

A mobile terminal including a display unit, the mobile terminal including:

an imaging unit being configured to capture images of a face and a surface of an eyeball of a user of the mobile terminal, the imaging unit being fixed relatively to the display unit;

an angle detection unit being configured to detect an absolute angle of the display unit with respect to a vertical direction; and

a control unit being configured to determine that the user is in the middle of operating the mobile terminal when it is determined from the image of the face and the absolute angle that the face is oriented downward relative to a predetermined angle, and further when, within a first predetermined time period, a time period during which the image of the surface of the eyeball matches with an image being displayed on the display unit is equal to or longer than a second predetermined time period that is shorter than the first predetermined time period.

### Supplementary Note 4

A mobile terminal including a display unit, the mobile terminal including:

an imaging unit being configured to capture images of a face and a surface of an eyeball of a user of the mobile terminal, the imaging unit being fixed relatively to the display unit;

a movement detection unit being configured to detect movement of a location of the mobile terminal;

an angle detection unit being configured to detect an absolute angle of the display unit with respect to a vertical direction; and

a control unit being configured to determine that the user is in the middle of operating the mobile terminal when it is detected that the mobile terminal is moving and it is determined from the image of the face and the absolute angle that the face is oriented downward relative to a predetermined angle, and further when, within a predetermined time period, the number of times that the image of the surface of the eyeball matches with an image being displayed on the display unit reaches a predetermined number of times.

### Supplementary Note 5

The mobile terminal according to any one of supplementary notes 1 to 4, wherein

the control unit stops receiving an operation of the mobile terminal from the user when it is determined that the user is in the middle of operating the mobile terminal.

### Supplementary Note 6

The mobile terminal according to supplementary note 5, wherein

the control unit further restores an operation of the mobile terminal to a receivable state when a predetermined time period elapses after reception of an operation of the mobile terminal from the user is stopped.

### Supplementary Note 7

A control method for a mobile terminal, including:

determining that a user of a mobile terminal is in the middle of operating the mobile terminal when, within a first predetermined time period, a time period during which an image of a surface of an eyeball of the user matches with an image being displayed on a display unit is equal to or longer than a second predetermined time period that is shorter than the first predetermined time period.

### Supplementary Note 8

A control method for a mobile terminal, including:

determining that a user of a mobile terminal is in the middle of operating the mobile terminal when, within a predetermined time period, the number of times that an image of a surface of an eyeball of the user matches with an image being displayed on a display unit of the mobile terminal reaches a predetermined number of times.

### Supplementary Note 9

A control method for a mobile terminal, including:

determining that a user of a mobile terminal is in the middle of operating the mobile terminal when it is determined from an image of a face of the user and an absolute angle of a display unit of the mobile terminal with respect to a vertical direction that the face is oriented downward relative to a predetermined angle, and further when, within a first predetermined time period, a time period during which an image of a surface of an eyeball of the user matches with an image being displayed on the display unit is equal to or longer than a second predetermined time period that is shorter than the first predetermined time period.

### Supplementary Note 10

A control method for a mobile terminal, including:

determining that a user of a mobile terminal is in the middle of operating the mobile terminal when it is detected that the mobile terminal is moving and it is determined from an image of a face of the user and an absolute angle of a display unit of the mobile terminal with respect to a vertical direction that the face is oriented downward relative to a predetermined angle, and further when, within a predetermined time period, the number of times that an image of a surface of an eyeball of the user matches with an image being displayed on the display unit reaches a predetermined number of times.

### Supplementary Note 11

The control method for a mobile terminal according to any one of supplementary notes 7 to 10, further including

stopping reception of an operation of the mobile terminal from the user when it is determined that the user is in the middle of operating the mobile terminal.

### Supplementary Note 12

The control method for a mobile terminal according to supplementary note 11, further including

restoring an operation of the mobile terminal to a receivable state when a predetermined time period elapses after reception of an operation of the mobile terminal from the user is stopped.

### Supplementary Note 13

A program for a mobile terminal, for causing a computer to execute a process of determining that a user of a mobile terminal is in the middle of operating the mobile terminal when, within a first predetermined time period, a time period during which an image of a surface of an eyeball of the user matches with an image being displayed on a display unit of the mobile terminal is equal to or longer than a second predetermined time period that is shorter than the first predetermined time period.

### Supplementary Note 14

A program for a mobile terminal, for causing a computer to execute a process of determining that a user of a mobile terminal is in the middle of operating the mobile terminal when, within a predetermined time period, the number of times that an image of a surface of an eyeball of the user matches with an image being displayed on a display unit of the mobile terminal reaches a predetermined number of times.

### Supplementary Note 15

A program for a mobile terminal, for causing a computer to execute a process of determining that a user of a mobile terminal is in the middle of operating the mobile terminal when it is determined from an image of a face of the user of and an absolute angle of a display unit of the mobile terminal with respect to a vertical direction that the face is oriented downward relative to a predetermined angle, and further when, within a first predetermined time period, a time period during which an image of a surface of an eyeball of the user matches with an image being displayed on the display unit is equal to or longer than a second predetermined time period that is shorter than the first predetermined time period.

### Supplementary Note 16

A program for a mobile terminal, for causing a computer to execute a process of determining that a user of a mobile terminal is in the middle of operating the mobile terminal when it is detected that the mobile terminal is moving and it is determined from an image of a face of the user and an absolute angle of a display unit of the mobile terminal with respect to a vertical direction that the face is oriented downward relative to a predetermined angle, and further when, within a predetermined time period, the number of times that an image of a surface of an eyeball of the user matches with an image being displayed on the display unit is equal to or more than a predetermined number of times.

### Supplementary Note 17

The program for a mobile terminal according to any one of supplementary notes 13 to 16, the program further causing a computer to stop reception of an operation of the mobile terminal from the user when it is determined that the user is in the middle of operating the mobile terminal.

### Supplementary Note 18

The program for a mobile terminal according to supplementary note 17, the program further causing a computer to restore an operation of the mobile terminal to a receivable state when a predetermined time period elapses after reception of an operation of the mobile terminal from the user is stopped.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-020711, filed on Feb. 8, 2018, the disclosure of which is incorporated herein in its entirety by reference.

### REFERENCE SIGNS LIST

10 Mobile terminal
11 Display unit
12 Imaging unit
13 Control unit
20 Mobile terminal
21 Display unit
22 Imaging unit
23 Angle detection unit
24 Control unit
30 Mobile terminal
31 Display unit
32 Imaging unit
33 Angle detection unit
34 Movement detection unit
35 Control unit

What is claimed is:

1-18. (canceled)

19. A mobile terminal, comprising
a display unit;
an imaging unit configured to capture an image of a surface of an eyeball of a user of the mobile terminal, the imaging unit being fixed relatively to the display unit; and
a control unit configured to determine, based on the image of the surface of the eyeball, whether the user is in middle of operating the mobile terminal.

20. The mobile terminal according to claim 19, wherein
the control unit is configured to determine that the user is in middle of operating the mobile terminal when, within a first predetermined time period, a time period during which the image of the surface of the eyeball matches with an image being displayed on the display unit is equal to or longer than a second predetermined time period that is shorter than the first predetermined time period.

21. The mobile terminal according to claim 19, wherein
the control unit is configured to determine that the user is in middle of operating the mobile terminal when, within a predetermined time period, a number of times that the image of the surface of the eyeball matches with an image being displayed on the display unit reaches a predetermined number of times.

22. The mobile terminal according to claim 19, further comprising
an angle detection unit configured to detect an absolute angle of the display unit with respect to a vertical direction, wherein
the imaging unit is configured to capture images of a face and the surface of the eyeball of the user of the mobile terminal, and
the control unit is configured to determine that the user is in middle of operating the mobile terminal when it is determined from the image of the face and the absolute angle that the face is oriented downward relative to a predetermined angle, and further when, within a first predetermined time period, a time period during which the image of the surface of the eyeball matches with an image being displayed on the display unit is equal to or longer than a second predetermined time period that is shorter than the first predetermined time period.

23. The mobile terminal according to claim 19, further comprising
a movement detection unit configured to detect movement of a location of the mobile terminal, and
an angle detection unit configured to detect an absolute angle of the display unit with respect to a vertical direction, wherein
the imaging unit is configured to capture images of a face and the surface of the eyeball of the user of the mobile terminal, and
the control unit is configured to determine that the user is in middle of operating the mobile terminal when it is detected that the mobile terminal is moving and it is determined from the image of the face and the absolute angle that the face is oriented downward relative to a predetermined angle, and further when, within a predetermined time period, a number of times that the image of the surface of the eyeball matches with an image being displayed on the display unit reaches a predetermined number of times.

24. The mobile terminal according to claim 19, wherein
the control unit stops receiving an operation of the mobile terminal from the user when it is determined that the user is in middle of operating the mobile terminal.

25. The mobile terminal according to claim 24, wherein
the control unit further restores the operation of the mobile terminal to a receivable state when a predetermined time period elapses after the receiving of the operation of the mobile terminal from the user is stopped.

26. A control method for a mobile terminal, comprising
obtaining an image of a surface of an eyeball of a user of the mobile terminal; and
determining, based on the image of the surface of the eyeball of the user, whether the user of the mobile terminal is in middle of operating the mobile terminal.

27. The control method for the mobile terminal according to claim 26, wherein
the determining includes determining that the user of the mobile terminal is in middle of operating the mobile terminal when, within a first predetermined time period, a time period during which the image of the surface of the eyeball of the user matches with an image being displayed on a display unit of the mobile terminal is equal to or longer than a second predetermined time period that is shorter than the first predetermined time period.

28. The control method for the mobile terminal according to claim 26, wherein
the determining includes determining that the user of the mobile terminal is in middle of operating the mobile terminal when, within a predetermined time period, a number of times that the image of the surface of the eyeball of the user matches with an image being displayed on a display unit of the mobile terminal reaches a predetermined number of times.

29. The control method for the mobile terminal according to claim 26, further comprising
obtaining an image of a face of the user and an absolute angle of a display unit of the mobile terminal with respect to a vertical direction, wherein
the determining includes determining that the user of the mobile terminal is in middle of operating the mobile terminal when it is determined from the image of the face of the user and the absolute angle of the display unit that the face is oriented downward relative to a predetermined angle, and further when, within a first predetermined time period, a time period during which the image of the surface of the eyeball of the user matches with an image being displayed on the display unit is equal to or longer than a second predetermined time period that is shorter than the first predetermined time period.

30. The control method for the mobile terminal according to claim 26, further comprising
obtaining an image of a face of the user and an absolute angle of a display unit of the mobile terminal with respect to a vertical direction, wherein
the determining includes determining that the user of the mobile terminal is in middle of operating the mobile terminal when it is detected that the mobile terminal is moving and it is determined from the image of the face of the user and the absolute angle of the display unit that the face is oriented downward relative to a predetermined angle, and further when, within a predetermined time period, a number of times that the image of the surface of the eyeball of the user matches with an image being displayed on the display unit reaches a predetermined number of times.

31. The control method for the mobile terminal according to claim 26, further comprising
stopping reception of an operation of the mobile terminal from the user when it is determined that the user is in middle of operating the mobile terminal.

32. The control method for the mobile terminal according to claim 31, further comprising
restoring the operation of the mobile terminal to a receivable state when a predetermined time period elapses after the reception of the operation of the mobile terminal from the user is stopped.

33. A non-transitory computer-readable storage medium storing a program for a mobile terminal, for causing a computer to execute a process of determining, based on an image of a surface of an eyeball of a user of the mobile terminal, whether the user of the mobile terminal is in middle of operating the mobile terminal.

34. The non-transitory computer-readable storage medium according to claim 33, wherein
the determining includes determining that the user of the mobile terminal is in middle of operating the mobile terminal when, within a first predetermined time period, a time period during which the image of the surface of the eyeball of the user matches with an image being displayed on a display unit of the mobile terminal is equal to or longer than a second predetermined time period that is shorter than the first predetermined time period.

35. The non-transitory computer-readable storage medium according to claim 33, wherein
the determining includes determining that the user of the mobile terminal is in middle of operating the mobile terminal when, within a predetermined time period, a number of times that the image of the surface of the eyeball of the user matches with an image being displayed on a display unit of the mobile terminal reaches a predetermined number of times.

36. The non-transitory computer-readable storage medium according to claim 33, wherein
the process further includes obtaining an image of a face of the user and an absolute angle of a display unit of the mobile terminal with respect to a vertical direction, and
the determining includes determining that the user of the mobile terminal is in middle of operating the mobile terminal when it is determined from the image of the face of the user and the absolute angle of the display unit that the face is oriented downward relative to a predetermined angle, and further when, within a first predetermined time period, a time period during which the image of the surface of the eyeball of the user matches with an image being displayed on the display unit is equal to or longer than a second predetermined time period that is shorter than the first predetermined time period.

37. The non-transitory computer-readable storage medium according to claim 33, wherein
the process further includes obtaining an image of a face of the user and an absolute angle of a display unit of the mobile terminal with respect to a vertical direction, wherein
the determining includes determining that the user of the mobile terminal is in middle of operating the mobile terminal when it is detected that the mobile terminal is moving and it is determined from the image of the face of the user and the absolute angle of the display unit that the face is oriented downward relative to a predetermined angle, and further when, within a predetermined time period, a number of times that the image of the surface of the eyeball of the user matches with an image being displayed on the display unit reaches a predetermined number of times.

38. The non-transitory computer-readable storage medium according to claim 33, wherein
the process further includes stopping reception of an operation of the mobile terminal from the user when it is determined that the user is in middle of operating the mobile terminal.
